(19) United States
(12) Patent Application Publication
(10) Pub. No.: US 2026/0021890 A1
(43) Pub. Date: Jan. 22, 2026

(54) MODULAR AND PORTABLE ACCESSIBILITY LIFT SYSTEM FOR AIRCRAFT AND OTHER VEHICLES

(71) Applicant: Dylan Foley, Liberty Hill, TX (US)

(72) Inventor: Dylan Foley, Liberty Hill, TX (US)

(21) Appl. No.: 19/273,019

(22) Filed: Jul. 17, 2025

Related U.S. Application Data
(60) Provisional application No. 63/672,632, filed on Jul. 17, 2024.

(51) Int. Cl. B64D 9/00

(52) U.S. Cl. CPC B64D 9/00

(57) ABSTRACT

This disclosure describes systems, methods, and devices related to a portable accessibility system. The system may comprise two or more modular tracks configured to be temporarily and securely mounted onto aircraft stairs. The system may comprise a powered lift unit (PLU) movably mounted on the two or more modular tracks, wherein the PLU configured to counteract an angle of the aircraft stairs to provide a level surface. The system may comprise a hoist mechanism integrated within the PLU, wherein the hoist mechanism includes at least one lifting cable. The system may comprise a limit switch operably connected to the hoist mechanism, wherein the limit switch configured to halt hoist operation upon reaching a defined endpoint. The system may comprise a redundant cable routing such that a failure of one cable allows continued operation of the PLU.

### CROSS-REFERENCE TO RELATED APPLICATION(S)

This application claims the benefit of U.S. Provisional Application No. 63/672,632, filed Jul. 17, 2024, the disclosure of which is incorporated herein by reference as if set forth in full.

### TECHNICAL FIELD

This disclosure relates to aircraft accessibility devices, and more particularly, to Modular and Portable Accessibility Lift System for Aircraft and Other Vehicles.

### BACKGROUND

In the field of transportation, especially aviation, passengers with limited mobility often encounter significant barriers when accessing vehicles with elevated entry points. Traditional solutions for enabling access, such as built-in lifts or external support equipment, are generally non-portable, require extensive installation, and can be cost-prohibitive due to the need for specialized infrastructure. Consequently, there exists a continuous need for an innovative accessibility solution that is lightweight, easily portable, and adaptable across different transportation modes, offering enhanced autonomy and safety for individuals with mobility challenges.

### BRIEF DESCRIPTION OF THE DRAWINGS

FIG. 1 shows a modular track system, in accordance with one or more example embodiments of the present disclosure.

FIGS. 2A-2B show the Jetscalator fitted on aircraft stairs, in accordance with one or more example embodiments of the present disclosure.

FIGS. 3A-3B depict illustrative schematic diagrams for a modular track system, in accordance with one or more example embodiments of the present disclosure.

FIGS. 4A-4B depict illustrative schematic diagrams for a modular track system, in accordance with one or more example embodiments of the present disclosure.

FIG. 5 depicts an illustrative schematic diagram for modular track system, in accordance with one or more example embodiments of the present disclosure.

FIG. 6 illustrates a flow diagram of process for a modular track system, in accordance with one or more example embodiments of the present disclosure.

FIG. 7 shows a block diagram of a computer system, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them.

Access to aircraft equipped with folding “airstair” type doors present a significant challenge for those with limited mobility, including individuals who are incapacitated or experiencing temporary mobility issues due to injury or surgery. The current market solutions for providing access to these individuals require heavy and extensive ground support infrastructure, or they lack portability for aircraft use due to their excessive weight and size. What is essential is a solution in the form of a lightweight, self-powered, and easily portable stair lift device. This device would be designed with such considerations in weight and dimensions that it could be conveniently transported within the aircraft itself, enabling passengers with mobility restrictions to disembark safely at their destinations without the need for extensive ground support equipment or personnel.

In the realm of aviation, passengers with limited mobility face an array of challenges when embarking and disembarking from smaller aircraft that utilize folding airstair doors. Traditional methods for assisting these individuals often rely on cumbersome and non-portable infrastructure, with solutions that are typically heavy, complex, and demand significant ground support. This not only impedes the travel experience for those with disabilities or temporary mobility constraints but also places a logistical burden on airlines and ground personnel. Recognizing this gap, the modular track system (also referred to herein as the “Jetscalator”) has been envisioned to dismantle these barriers, offering an elegantly engineered solution that marries functionality and ease of use. Its introduction is set to revolutionize the way mobility-challenged passengers navigate the critical juncture between the tarmac and the cabin.

In one or more embodiments, example embodiments of the present disclosure relate to systems, methods, and devices for modular and portable accessibility lift system for aircraft and other vehicles.

In one or more embodiments, the Jetscalator is designed to tackle the challenge of air stair accessibility for passengers with limited mobility. An important component of the system's modular track, which is lightweight, foldable, and easily portable, avoiding the need for fixed ground support infrastructure. This track system can be attached to the aircraft door quickly through user-friendly mechanisms such as spring-loaded pins and straps or integral clamps, and it is designed to facilitate load-bearing without straining the aircraft's structure.

In one or more embodiments, complementing the track is the innovative Powered Lift Unit (PLU), a self-contained, battery-powered module that gracefully ascends and descends along the installed tracks. Its unique wedge shape maintains a level standing surface for passengers, even when navigating the inclined stairs, enhancing the ease of ingress and egress. The unit's notable safety features include an innovative double-rope system made from robust Dyneema® rope, ensuring continuous operation even if one attachment point fails. The built-in hoist is equipped with sophisticated control circuitry, sensors, and limit switches, culminating in a system that prioritizes passenger safety while streamlining operation.

Constructed from advanced materials selected for their strength-to-weight ratio and durability—such as Delrin® composite, stainless steel, aluminum, and potential alternatives like carbon fiber or titanium—the Jetscalator is built to offer reliable service in diverse conditions. These considered design choices result in a product that delivers an unprecedented blend of portability, safety, and convenience, setting a new standard for accessible aircraft stair solutions.

In one or more embodiments, a Jetscalator system may address the accessibility difficulties encountered with aircraft utilizing folding “air stair” type doors, which are currently not optimally designed for those with limited mobility. In one or more embodiments, the commercially available solutions to this challenge require extensive ground support infrastructure or are hindered by their lack of portability due to size and weight constraints, delineating a clear need for a more efficient system.

In one or more embodiments, what is required is a lightweight, self-powered, easily portable, and temporarily attachable stair lift type device. This device should be of such a design that it can be carried aboard the aircraft, allowing passengers with limited mobility to disembark safely without the need for additional ground support equipment or personnel.

In one or more embodiments, the Jetscalator air stair access device may possess several unique and innovative features making it stand apart from existing market offerings, addressing the lack of suitable solutions for aircraft accessibility for passengers with limited mobility.

In one or more embodiments, the modular track system utilizes a lightweight and easily foldable modular rail type track system which significantly simplifies the logistics of deploying such accessibility solutions on aircraft. The tracks rest upon the apex edges of the aircraft's folding air stair door and attach to the door with spring-loaded pins and rubber straps, or folding composite guide bars, offering quick installation methods that could be vital in emergencies or rapid turnaround scenarios. Notably, the tracks (also referred to as guide bars or modular tracks) may be engineered to fold in multiple interlocking sections. For example, using hinged design to fold the length of the tracks into smaller folded sections. That type of hinged design allows the tracks to collapse compactly for storage, further enhancing the system's portability and ease of use.

In one or more embodiments, the track system of the Jetscalator system is detachable, allowing the door to carry the system's loads as well as those of the passenger, similar to the loads experienced by a passenger with normal mobility. This consideration ensures the system's compatibility with existing aircraft designs without necessitating structural modifications.

In one or more embodiments, the modular tracks are designed to be easily portable in the baggage compartment or the interior of the aircraft, being crafted from a mix of Delrin composite, stainless steel, and aluminum along with rubberized components for maximum durability and weight-efficiency.

In one or more embodiments, a Powered Lift Unit (PLU) is another component of the Jetscalator system, incorporating a multifaceted design that pushes the boundaries of comfort, safety, and operability. The PLU may slide along the modular tracks (guide bars) using pillow bearings, which offer a smooth and constrained motion, critical to ensuring stability and passenger confidence during use.

In one or more embodiments, the PLU is wedge-shaped to match the inverse of the air stair angle of the aircraft, allowing the passenger to stand on a level surface while being lifted—a design insight directly related to enhancing the user experience.

In one or more embodiments, the PLU may also incorporate an innovative solution related to rope/cable routing and alignment that allows for fail-safe operation, an advancement that significantly contributes to the reliability and safety of the system.

In one or more embodiments, should there be a “cable-cut”, or support attach point failure, the PLU's rope/cable system ensures continued operation, exemplifying the system's built-in redundancy and resilience.

In one or more embodiments, the PLU's hoist is integrally mounted with its controlling circuitry, remote sensors, battery, and limit switch devices, creating a harmonized unit with all essential control features housed within.

In one or more embodiments, a limit switch stops the power supply to the hoist motor once the travel limit of the system is reached, reflecting a design that prioritizes passenger safety above all else.

With these embodiments, the Jetscalator system is positioned to provide a significant improvement in the realm of aircraft accessibility, offering a promising solution that aligns with the urgent needs of those facing mobility challenges.

The above descriptions are for the purpose of illustration and are not meant to be limiting. Numerous other examples, configurations, processes, algorithms, etc., may exist, some of which are described in greater detail below. Example embodiments will now be described with reference to the accompanying figures.

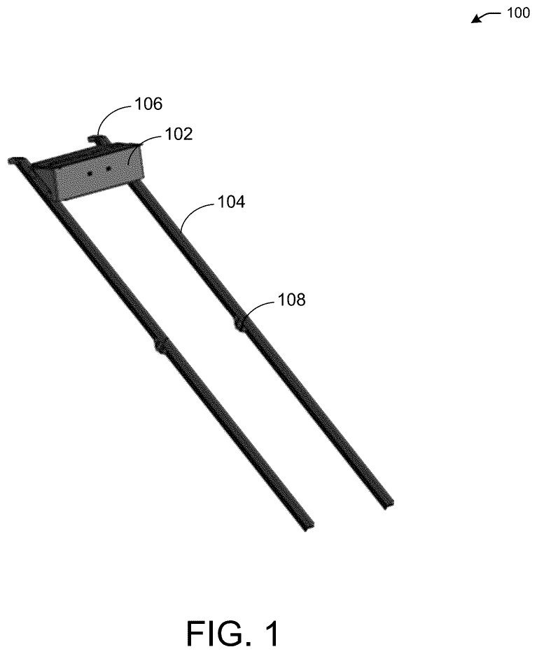

FIG. 1 illustrates the modular track system 100 (Jetscalator system), in accordance with one or more example embodiments of the present disclosure.

The present disclosure relates to the Jetscalator system, an innovative modular accessibility apparatus designed to facilitate boarding and disembarkation from aircraft and other vehicles. The system comprises several key components, each denoted by specific reference numbers for clarity in the accompanying figures.

As illustrated in FIG. 1, the Jetscalator system includes two modular tracks (104), which may be connected by a hinge (108) allowing the tracks to fold compactly for ease of transport and storage. Also shown is the Powered Lift Unit (PLU 102), which is tailored with a wedge-shaped profile to counteract the typical angle of aircraft stairs, ensuring a level platform for passengers at any elevation. The top brace (106) of the system is engineered to rest on and attach securely to the uppermost stair of an aircraft's airstair assembly.

In one or more embodiments, the PLU 102 incorporates advanced solutions for rope/cable routing and alignment, utilizing a double cable system to provide redundancy and ensure fail-safe operation in the event of a cable cut or attachment point failure. The PLU's hoist is integrally mounted with the control circuitry, remote sensors, battery, and limit switch devices, creating a harmonized unit that houses all essential controls within the lift module. A dedicated limit switch inhibits power to the hoist motor upon reaching the system's travel limit, underscoring the system's prioritization of passenger safety.

In FIG. 1, there is shown the Jetscalator system in isolation, captured without its positioning on the aircraft stairs to afford a detailed view of its individual components. The embodiment showcases the intricately engineered modular track system. The tracks display a precision-designed geometry intended to interlock seamlessly with an airstair's edges, reflecting the system's adaptability to various aircraft models. FIG. 1 features attachment regions where spring-loaded pins and rubber straps—or optional integral clamps—secure the tracks in place to the top step of airstair, pointing to the ease with which the Jetscalator system can be deployed.

The PLU 102 of the Jetscalator system may be shown as resting on the modular tracks. The wedge shape of the PLU, tailored to counterbalance the angle of typical airstairs, where its design elements are intended to offer passengers horizontal stability at any point of elevation.

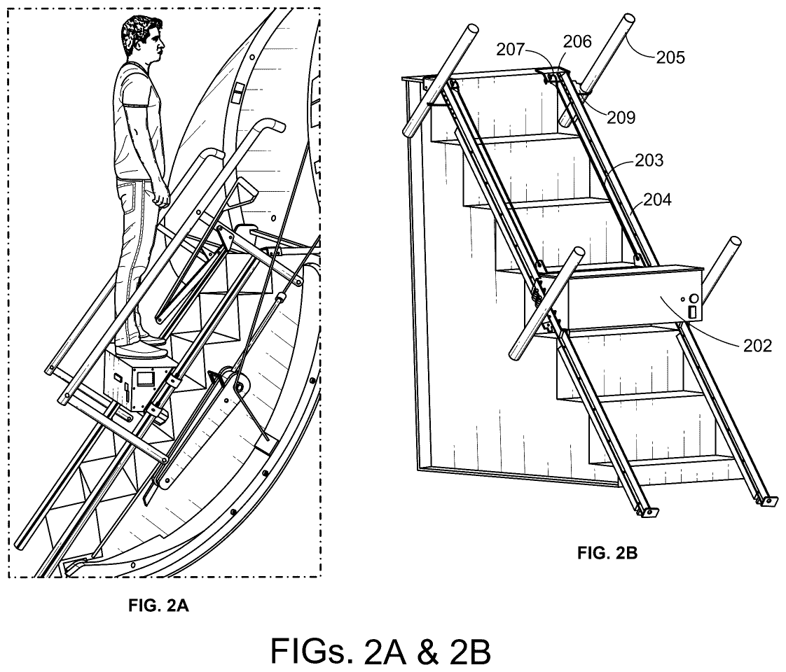

FIG. 2A shows the Jetscalator fitted on aircraft stairs, in accordance with one or more example embodiments of the present disclosure.

In one or more embodiments represented in FIG. 2A, the modular track system (Jetscalator) is illustrated fitted on top of an aircraft stairs, providing a visual exposition of its deployment for passenger use. FIG. 2A provides a clear perspective of the modular track system's alignment with the aircraft's airstair architecture. It converges seamlessly with the airstair's own foldable structure, highlighting the non-invasive design that avoids permanent fixtures or modifications to the aircraft. The system's intuitive attachment mechanism relies on spring-loaded pins and/or rubber straps, or a potential alternative of integrated clamps, assuring a secure yet readily detachable connection, enabling rapid installation or removal in line with the agile needs of the aviation industry.

In FIG. 2B, the modular track system is depicted fitted atop the aircraft stairs, showcasing the alignment of the modular track system with the aircraft's airstair architecture. The system's attachment mechanism at the top brace 206 using spring-loaded pins, rubber straps, or optional integrated clamps, which ensures a secure yet removable connection, allowing for rapid installation and removal without permanent modification to the aircraft.

Within the top brace 206, there is an oblong hole cable attachment designed to allow a cable 203 to be attached using a hook 207 to the top brace 206 on one side and to the PLU 202 from the other side, enabling smooth movement up and down while the top brace 206 remains securely fastened to the uppermost airstair step. During operation, the PLU 202 moves along the tracks (e.g., track 204, the second track is not labeled but shown to be parallel to track 204).

The modular track system is securely fastened and protected from lateral displacement by a specially engineered pivoting bracket 209. This bracket is mounted along the track and engages with a distinct grid hole pattern, enabling adaptable positioning to accommodate various placements of vertical handrails 205 (bannisters) on the airstair. The pivoting bracket 209 operates by rotating into position and locking firmly against the rails, ensuring they remain stationary and preventing any unintended side-to-side movement.

The PLU 202 of the Jetscalator system features a wedge-shaped design to match the inverse angle of airstairs, ensuring passengers remain on a level standing platform during ascent or descent. Constructed from materials such as Delrin composite, stainless steel, aluminum, or suitable alternatives, the PLU 202 is engineered to balance structural strength with the weight constraints vital for aircraft applications. This thoughtful material selection and design approach guarantees both passenger safety and efficient integration with varied aircraft models, while maintaining the core requirements for robust performance and portability.

In one or more embodiments, the PLU 202 is engineered to provide stable and secure entry to vehicles with elevated access points. The unit is designed with a platform that remains level during operation, which increases user safety.

In one or more embodiments, the construction of the PLU 202 utilizes lightweight yet strong composite materials. These materials are selected to make the unit easy to move and resistant to wear over time. For example, the use of advanced polymers and reinforced panels in the PLU allows it to be transported and set up by a single person, while still supporting the weight requirements needed for accessibility applications.

In one or more embodiments, the PLU 202 is designed for repeated use in different environments, such as airport tarmacs, vehicle access points, or temporary installations for events. For example, the unit can be detached from the vehicle and relocated as needed, providing flexible and adaptable accessibility solutions for a wide range of mobility needs.

In one or more embodiments, the PLU 202 of the Jetscalator system may be wedge-shaped to counteract the angle of airstairs, ensuring passengers remain level whether ascending or descending. Designed from materials such as Delrin composite, stainless steel, or aluminum, the PLU 202 balances structural integrity with the lightweight requirements essential in aviation. This results in a system that is robust, safe, and readily adaptable to various aircraft models, while prioritizing portability and user safety.

In one or more embodiments, the PLU 202 features a platform engineered to stay level throughout its operation, enhancing safety for users accessing elevated entry points on vehicles or aircraft. Its construction leverages advanced polymers and reinforced panels to achieve a lightweight yet durable unit, making it easy for a single person to transport and set up, while still supporting the weight necessary for accessibility applications. Adaptability is central to the PLU's design, enabling it to function seamlessly in multiple environments-whether at airport tarmacs, vehicle entry points, or temporary installations at events. The unit can be easily detached and relocated, providing versatile accessibility solutions suited for diverse mobility requirements.

In one or more embodiments, the Jetscalator can be adapted to a different mode of transportation, demonstrating its versatility beyond the aviation sector. For example, it can be attached to the rear of a vehicle, such as an SUV or a van, suggesting its utility in providing accessibility in various automotive contexts. The tracks would be shown to conform to the vehicle's structure with a robust yet easily reversible attachment system, indicating that the same principles that facilitate its ease of use in aviation are also applicable in automotive scenarios.

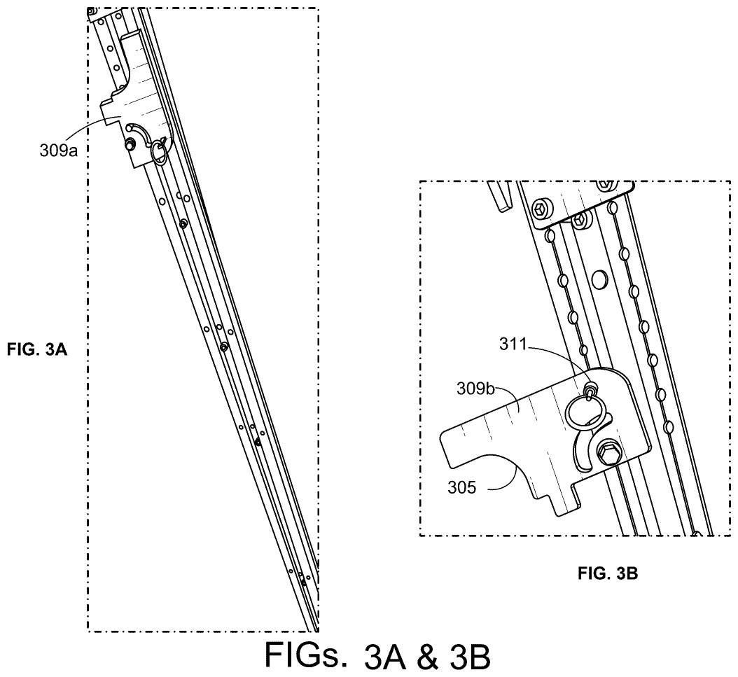

FIGS. 3A-3B depict illustrative schematic diagrams for a modular track system, in accordance with one or more example embodiments of the present disclosure.

Referring to FIGS. 3A and 3B, there is shown a bracket system that is part of the modular track system 100 (see also FIG. 1). This bracket system prevents unwanted vertical or angled movement along the air stair structure. The bracket system may comprise multiple brackets 309 (also shown as bracket 209 in FIG. 2B) pivoted outward from the tracks in opposite directions, bracing the Jetscalator tracks securely against the vertical or angled banisters. It should be noted that only one bracket 309 is shown here, however, the multiple brackets 309 may be placed along each track of the modular track system. For example, bracket 309 can be positioned folded underneath the track (309a in FIG. 3A) or folded out from the track (309b in FIG. 3B). Pins 311 secure the brackets in place, and their placement can be adjusted along the tracks to fit various aircraft stairs.

To switch between use and storage, a locking ring (e.g., pins 311) mechanism is included. This ring keeps the bracket in its stowed (unused) position when not needed or securely locks it in the extended (in-use) position during operation. The entire mechanism pivots on sturdy bolts, which act as both hinge pins (allowing rotation) and guides that travel within an arc-shaped slot. This arc-shaped slot restricts the bracket's movement to a controlled path, making it simple and reliable to deploy or retract the bracket as necessary. These intuitive features together ensure that the system remains stable and easy to operate, even in varied or challenging installation environments.

In one or more embodiments, two brackets 309 can be positioned so that the curved side 305 of one bracket secures a first banister from one direction, while the curved side 305 of a second bracket supports a second banister from the opposite direction. For instance, when installed on emergency evacuation stairs, brackets 309 ensure the rails remain fixed, providing unwavering support as individuals move up or down, and thereby enhancing overall safety.

In one or more embodiments, the brackets 309 can be constructed of polymer or metal, depending on design requirements or specific use cases. For example, in an aircraft boarding scenario, where lightweight materials are often essential, polymer brackets could be utilized for their strength and reduced weight.

These brackets, engineered from either polymer or metal in accordance with design specifications and operational requirements, employ pins to secure their positions along the tracks and can be installed at various points to accommodate different aircraft stair configurations. In applications such as aircraft boarding, where minimizing weight is essential, polymer brackets may be due to their optimal balance of strength and low mass. This adaptable design enables the brackets to deliver stable and adjustable support for the Jetscalator, making it suitable for aviation and any other context where robust, lightweight solutions are required.

It is understood that the above descriptions are for the purposes of illustration and are not meant to be limiting.

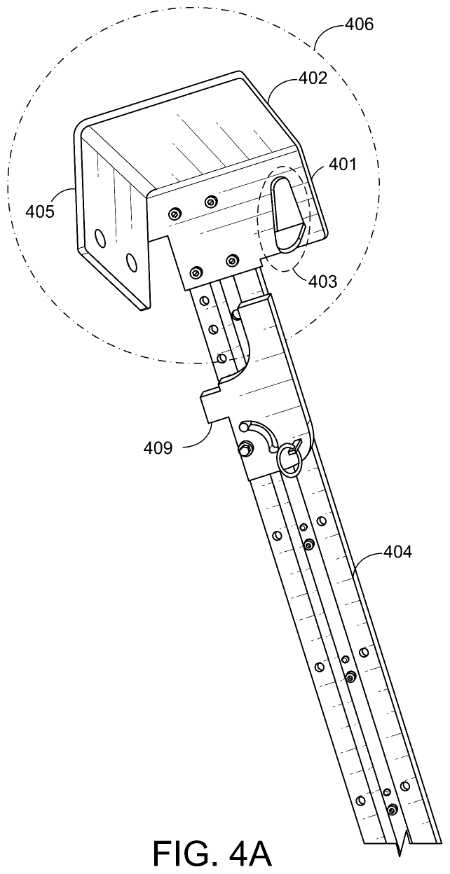

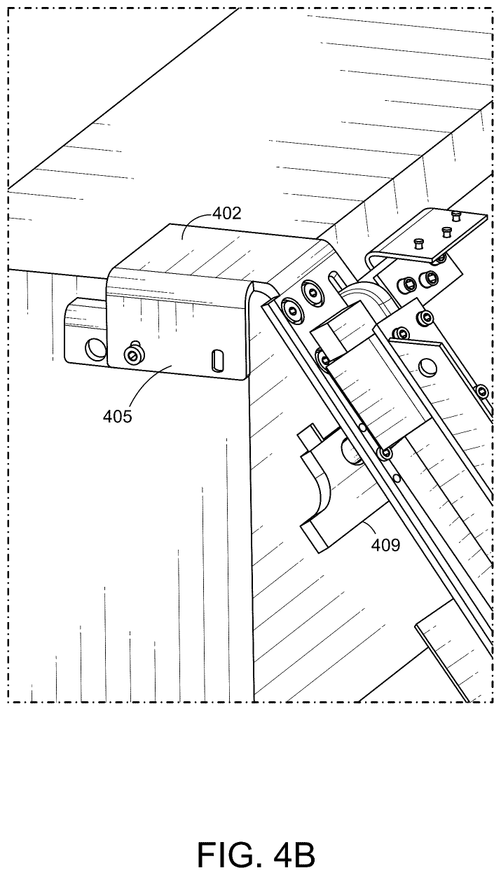

FIGS. 4A-4B depict illustrative schematic diagrams for a modular track system, in accordance with one or more example embodiments of the present disclosure.

Referring to FIG. 4A, there is shown a modular track system that incorporates a specifically designed top brace 406, tailored according to the aircraft type. Further, in FIG. 4A, there is shown pivoting bracket 409 in a folded in position along track 404. A break angle between the top surface 402 and the angled surface 401 aligns with the slope of the aircraft stairs, enabling secure attachment that supports both the device and its occupant at the apex of the top stair, transferring weight to the underlying support structure. For example, on a regional jet with a steeper stair angle, top brace 406 is manufactured to fit that particular incline, ensuring the Jetscalator system can be securely mounted and properly supported. This custom fit helps distribute the weight of both the device and the person using it across the strongest part of the stairs. Additionally, this component features an integrated oblong hole cable attachment 403, facilitating the connection of lifting unit cable ends (e.g., PLU 202).

In one or more embodiments, the integrated oblong hole cable attachment 403 is used to connect the lifting cable to the main structure. An oblong hole refers to a hole that is longer in one direction than the other, essentially, an elongated or oval-shaped opening rather than a perfect circle. For example, when installing the Jetscalator on an aircraft, the technician threads the cable ends through the oblong hole cable attachment 403 in the top brace 406, anchoring the lifting mechanism directly to the support brace. This attachment method ensures stability and provides a reliable connection point for the cable, which is essential for the safe operation of the system.

In one or more embodiments, these design features work together to simplify installation and improve safety. For example, since top brace 406 is custom-fit and includes a purpose-built cable attachment, ground crews can attach and detach the Jetscalator efficiently during aircraft turnaround operations, reducing setup time and minimizing the risk of errors.

Referring to FIG. 4B, there is shown the installation of top brace 406 on a stair of an aircraft. Top surface 402 is shown to be resting on a horizontal surface of the stair, while side surface 405 is attached to a vertical side of the stairs.

Several mechanisms can be envisioned to allow attachment to the side of the stairs, including but not limited to:
Adjustable clamping systems that can be tightened against the stairs side to ensure a secure fit.
2. Quick-release latch assemblies, enabling fast, tool-free installation and removal.
3. Bolt-through brackets with pre-drilled holes for semi-permanent installations.
4. Magnetic locking mechanisms for metal staircases, providing a non-invasive yet sturdy hold.
5. Hook-and-slot designs that use the stairs' geometry for simple, gravity-assisted anchoring.

These varied options allow the Jetscalator system to adapt to different stair configurations, ensuring both secure attachment and ease of use in diverse operational environments.

Further in FIG. 4B, there is shown pivoting bracket 409 to be in a pivoted outward from the tracks position.

It is understood that the above descriptions are for the purposes of illustration and are not meant to be limiting.

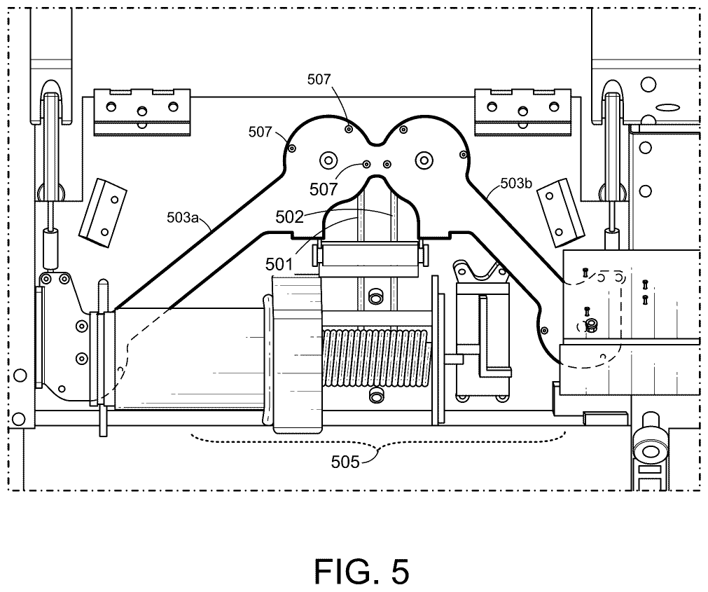

FIG. 5 depicts an illustrative schematic diagram for a modular track system, in accordance with one or more example embodiments of the present disclosure.

Referring to FIG. 5, there is shown some interior component of a PLU 502. It should be noted that not all components of PLU 502 are shown, for example, electrical control systems are not visible here in order to show the plurality of cable assembly and safety mechanisms that are part of PLU 502.

In FIG. 5, there is shown, a tension splitter device 502 (shown in thicker line in FIG. 5). This tension splitter device 502 routes a number of cables from a winch 505 into two sides (e.g., side 503a, and side 503b). For example, two cables 501 and 502 may be shown in this figure. Cable 501 routes through side 503a and cable 502 routes through side 503b.

Tension splitter device 502 may be a constant friction/tension splitter device. It is a unique feature in the Jetscalator's design. This device is engineered to hold the lifting cable or cables (e.g., cables 501 and 502) in place when there is no load applied. It does this by utilizing the stiffness of the cable itself, which naturally presses outward against the curve or radius of the bends in the system. The cable's force is managed by rolling alignment pins 507 which act as guides to keep the cable on its correct path. These rolling alignment pins 507 may be encased in nylon rollers, which are cylindrical components that spin to reduce friction and allow the cable to glide smoothly. While nylon is a common choice for these rollers due to its durability and low friction, other materials such as PVC (polyvinyl chloride), stainless steel, or various polymers could also be used depending on specific requirements. This careful combination of components ensures that the cable remains properly constrained and aligned, increasing both the safety and efficiency of the Jetscalator system.

In one or more embodiments, the inclusion of rollers 507 (e.g., three or more rollers) that are small cylindrical components that guide and support movement of the cables within tension splitter device 502 adds an essential layer of safety by keeping the lifting cable precisely on track. For instance, as the cable (e.g. cable 501 and/or cable 502) moves during operation, these rollers 507 act much like the rails that keep the cable properly aligned, preventing the cable from slipping or veering out of place. This ensures that the cable travels within its designated path and cannot exceed the intended stopping point, reducing the risk of operational errors and equipment failure.

In one or more embodiments, the system's design prioritizes reliable cable alignment and precise stopping action. For example, the combination of the electrical limit switch, ferrule shut-off trigger, and rollers ensures that the lifting cable not only stops at the appropriate position but also stays properly aligned for safe and efficient ongoing use.

In one or more embodiments, an electrical limit switch (not shown in the figures) and integrated pulley design for constant passive cable alignment. The novel combination of the ferrule of the lifting cable used as a shut off trigger on the up limit for the circuitry logic is unique in the design of the Jetscalator.

In one or more embodiments, the electrical limit switch and integrated pulley system work together to ensure that the lifting cable automatically stops at the precise upper position. The electrical limit switch is a sensor device that detects when the cable reaches its endpoint, instantly signaling the system to halt movement. The integrated pulley is a wheel around which the cable runs, helping to guide and align the cable smoothly as it moves. The ferrule, a small metal cap attached to the cable's end, acts as a physical trigger—when it comes into contact with the limit switch, it activates the shut-off mechanism in the system's controller, preventing further movement and ensuring the cable does not exceed its intended range. This coordinated mechanism not only stops the cable at the correct position but also enhances both reliability and safety during operation.

It is understood that the above descriptions are for the purposes of illustration and are not meant to be limiting.

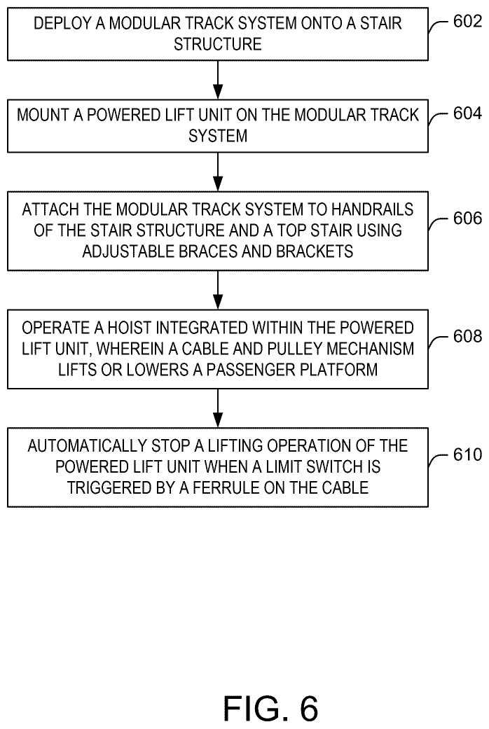

FIG. 6 illustrates a flow diagram of illustrative process 600 for a Jetscalator system, in accordance with one or more example embodiments of the present disclosure.

At block 602, a device may deploy a modular track system onto a stair structure.

At block 604, the device may mount a powered lift unit on the modular track system.

At block 606, the device may attach the modular track system to handrails of the stair structure and a top stair using adjustable braces and brackets.

At block 608, the device may operate a hoist integrated within the powered lift unit, wherein a cable and pulley mechanism lifts or lowers a passenger platform.

At block 610, the device may automatically stop a lifting operation of the powered lift unit when a limit switch is triggered by a ferrule on the cable.

It is understood that the above descriptions are for the purposes of illustration and are not meant to be limiting.

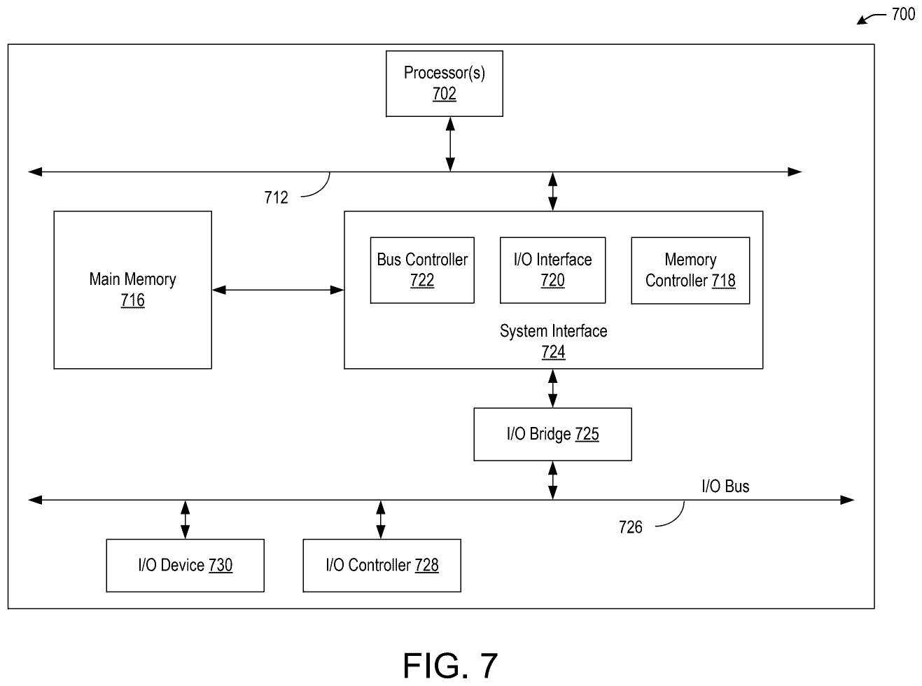

FIG. 7 presents a block diagram of a computer system, designated 700, detailing its structure and the interconnection of components relevant to one or more exemplary embodiments. This system framework is capable of performing a variety of computational methodologies defined in the disclosure.

Central to the system, the processor(s), referred to as 702, are configured with multi-core architectures to manage parallel processing of operations efficiently. These processor(s) integrate with advanced instruction sets to maximize performance and execution speed, complying with defined energy consumption parameters for operational efficiency.

The Processor bus 712 serves as a communication backbone, providing a data transfer channel that is broad in bandwidth, employing a high-speed interconnect protocol. It features mechanisms for error detection and correction to maintain the integrity of data transactions between the processor(s) and the connected system components.

Main Memory 716, interfaced with the System Interface 724, provides volatile storage for the immediate accessibility of data and instructions. Memory specification entails type, timing, and capacity parameters aligned with processor(s) and system interface requirements.

The System Interface 724 is composed of three primary subcomponents:
1. The Memory controller 718 manages memory read/write operations and access sequences, supporting dual-channel configurations for enhanced data transfer rates.
2. The Bus controller 722 balances the processor bus demand, facilitating data packet prioritization and employing congestion management protocols.
3. The I/O Interface 720 executes data transmission functions compliant with various interface standards and incorporates hardware-level security features for secure data exchange.

The I/O Bridge 725 provides a mediation layer between the System Interface 724 and peripheral devices, incorporating latency-optimized pathways and data buffering techniques for consistent peripheral performance.

Communication through the I/O Bus 726 is tailored for peripheral device interaction. This bus supports high transfer rates and is compatible with multiple interface standards, providing a scalable solution to peripheral connectivity.

The I/O Controller 728 orchestrates peripheral device communications, featuring support for synchronous and asynchronous data transfers, and is capable of managing a wide array of I/O device protocols and formats.

Lastly, the I/O Device 730 encompasses a broad spectrum of external devices that can be interfaced with the computer system 700. It details the interaction and data handling protocols which are necessary for device functionality and interaction with the core system.

Collectively, these components form an integrated computational apparatus within computer system 700, designed for rigorous demand scalability, data throughput, security, and energy efficiency. Each component is defined not only by its individual operational capacity but also by its capability to integrate with other system elements, illustrating a design ethos centered on the thorough, controlled coordination of computing resources. The description herein places a clear emphasis on the systematic integration and specification of each system element, pursuant to the disclosed embodiments.

In accordance with one embodiment, the operational procedures and methodologies may be executed by the computer system 700 in response to the processor(s) 702 executing one or more sequences of instructions residing in the main memory 716. These instructions may be loaded into the main memory 716 from another machine-readable medium, such as a storage device, thereby facilitating the execution process.

When executed by the processor(s) 702, the sequences of instructions contained within the main memory 716 instigate the performance of the process steps delineated throughout the disclosure. These processes can extend to, but are not limited to, the management of data workflows, computational tasks, and the synchronization of I/O operations, as structured by the specified instructions.

Alternative embodiments may see the utilization of dedicated circuitry, either in lieu of or supplementary to software-based instruction execution. This may entail the deployment of application-specific integrated circuits (ASICs) or programmable logic devices (PLDs) that are structured to perform the disclosed methods.

Therefore, the embodiments encompassed within the present disclosure may integrate a confluence of hardware and software components. The use of hardware, in conjunction with software instructions, provides a versatile platform capable of achieving the targeted functionalities through a variety of execution modalities, reflecting the system's design to accommodate diverse operational paradigms.

The word “exemplary” is used herein to mean “serving as an example, instance, or illustration.” Any embodiment described herein as “exemplary” is not necessarily to be construed as preferred or advantageous over other embodiments.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Embodiments of the present disclosure may be integrated into an extensive range of modern computing devices and systems. These include general-purpose computers, such as desktop and server computers; various forms of mobile computers, including laptops, notebooks, tablets; handheld devices like smartphones; as well as specialized computing systems used for industrial purposes.

Furthermore, the disclosed embodiments have utility across different communication and smart devices. This encompasses devices such as wearable technology, personal digital assistants (PDAs), devices used in machine-to-machine communications, Internet of Things (IoT) devices, and equipment within vehicular and non-vehicular systems.

In addition to general computing devices, embodiments may be beneficially used with a spectrum of communication technologies. Devices covered include, but are not limited to, mobile phones, smartphones, PCS devices, PDAs that incorporate wireless communication capabilities, GPS-enabled devices, and those with embedded RFID or NFC technology. Communication system implementations may involve various configurations, including MIMO, SIMO, and MISO transceivers, devices utilizing internal or external antennas, and technologies that enable digital video broadcasting.

The applicability of embodiments also extends to support a variety of wireless communication signals and systems, engaging with multiple wireless communication protocols. This comprehends traditional and emerging wireless protocols, including RF, IR, FDM, OFDM, TDM, TDMA, GPRS, various forms of CDMA such as WCDMA and CDMA2000, along with more recent standards like Bluetooth®, ZigBee, UWB, current Wi-Fi iterations, and LTE protocols including LTE Advanced. Emphasis is placed on compatibility and forward-compatibility with evolving wireless network technologies, including fifth-generation (5G) mobile networks and the anticipated emergence of sixth-generation (6G) telecommunications, as well as next-generation radio access networks and services anticipated in future wireless communication frameworks. This ensures the embodiments remain relevant and adaptable to the progression of wireless communication standards.

The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An accessibility apparatus for facilitating boarding and disembarkation from an aircraft, comprising:
two or more tracks configured to be temporarily and securely mounted onto aircraft stairs;
a powered lift unit (PLU) movably mounted on the two or more tracks, wherein the PLU configured to counteract an angle of the aircraft stairs to provide a level surface;
a hoist mechanism integrated within the PLU, wherein the hoist mechanism includes at least one lifting cable;
a limit switch operably connected to the hoist mechanism, wherein the limit switch configured to halt hoist operation upon reaching a defined endpoint; and
a redundant cable routing such that a failure of one cable allows continued operation of the PLU.

2. The apparatus of claim 1, wherein the two or more tracks comprises at least one pivoting bracket and a top brace.

3. The apparatus of claim 2, wherein the pivoting bracket being positionable to engage and stabilize the apparatus relative to a variety of stair rail configurations.

4. The apparatus of claim 1, wherein the PLU is constructed from lightweight composite materials selected from the group consisting of Delrin composite, aluminum, stainless steel, or reinforced polymers.

5. The apparatus of claim 1, wherein the lifting cable includes a ferrule at its end, the ferrule configured to physically trigger the limit switch when the PLU reaches an upper travel limit.

6. The apparatus of claim 1, further comprising a tension splitter device with at least two rollers to maintain cable alignment and distribution of load between multiple cable paths.

7. The apparatus of claim 1, wherein two or more tracks comprises a hinge mechanism allowing the tracks to fold for storage and transport.

8. The apparatus of claim 1, wherein two or more tracks includes a top brace based at least in part on a type of the aircraft.

9. The apparatus of claim 8, wherein the top brace is designed to match a slope of the aircraft stairs.

10. The apparatus of claim 8, wherein the top brace comprises an oblong hole cable attachment.

11. A system for facilitating boarding and disembarkation from an aircraft, comprising:
two or more modular tracks configured to be temporarily and securely mounted onto aircraft stairs;
a powered lift unit (PLU) movably mounted on the two or more modular tracks, wherein the PLU configured to counteract an angle of the aircraft stairs to provide a level surface;
a hoist mechanism integrated within the PLU, wherein the hoist mechanism includes at least one lifting cable;
a limit switch operably connected to the hoist mechanism, wherein the limit switch configured to halt hoist operation upon reaching a defined endpoint; and
a redundant cable routing such that a failure of one cable allows continued operation of the PLU.

12. The system of claim 11, wherein two or more tracks comprises a pivoting bracket and a top brace.

13. The system of claim 12, wherein the pivoting bracket being positionable to engage and stabilize the system relative to a variety of stair rail configurations.

14. The system of claim 11, wherein the PLU is constructed from lightweight composite materials selected from the group consisting of Delrin composite, aluminum, stainless steel, or reinforced polymers.

15. The system of claim 11, wherein the lifting cable includes a ferrule at its end, the ferrule configured to physically trigger the limit switch when the PLU reaches an upper travel limit.

16. The system of claim 11, further comprising a tension splitter device with at least two rollers to maintain cable alignment and distribution of load between multiple cable paths.

17. A method for providing accessible boarding and disembarkation to elevated entry points, comprising:
deploying a modular track system onto a stair structure;
mounting a powered lift unit on the modular track system;
attaching the modular track system to handrails of the stair structure and a top stair using adjustable braces and brackets;
operating a hoist integrated within the powered lift unit, wherein a cable and pulley mechanism lifts or lowers a passenger platform;
automatically stopping a lifting operation of the powered lift unit when a limit switch is triggered by a ferrule on the cable.

18. The method of claim 17, further comprising folding the modular track system via a hinge mechanism for transportation and storage.

19. The method of claim 17, wherein the adjustable braces and brackets include spring-loaded pins, rubber straps, or integral clamps for attachment to various stair geometries.

20. The method of claim 17, wherein the modular track system includes pivoting brackets with arc-shaped slots and locking pins to accommodate varying stair banister positions and enhance lateral stability.
